(19) United States
(12) Patent Application Publication
(10) Pub. No.: US 2019/0163938 A1
(43) Pub. Date: May 30, 2019

(54) CONTROL METHOD OF CARD READER AND CARD READER

(71) Applicant: NIDEC SANKYO CORPORATION, Suwa-gun (JP)

(72) Inventor: Yasuhiro KITAZAWA, Suwa-gun (JP)

(21) Appl. No.: 16/202,722

(22) Filed: Nov. 28, 2018

(30) Foreign Application Priority Data
Nov. 29, 2017 (JP) 2017-228657

(51) Int. Cl. G06K 7/08

(52) U.S. Cl. CPC G06K 7/087

(57) ABSTRACT

A control method of a card reader having a magnetic sensor, a magnetic head, a card conveying passage, and a conveyance mechanism may include at a predetermined timing set in advance, regardless of whether the magnetic stripe is detected, conveying the card inserted into the card insertion slot in the first direction to be subjected to the magnetic processing operation while passing through the magnetic processing position and then conveying the card in the second direction to be ejected from the card insertion slot, and when the magnetic stripe is detected based on a signal from the magnetic head in the magnetic processing operation but is not detected based on a signal from the magnetic sensor, determining that an abnormality occurs in the magnetic sensor.

### CROSS REFERENCE TO RELATED APPLICATIONS

The present application claims priority under 35 U.S.C. § 119 to Japanese Application No. 2017-228657 filed Nov. 29, 2017, the entire content of which is incorporated herein by reference.

### BACKGROUND

At least an embodiment of the present invention relates to a control method of a card reader that processes a card including a magnetic stripe and an IC chip, and the card reader.

Japanese Unexamined Patent Application Publication No. 2012-118689 describes a card reader that performs processing on a card including a magnetic stripe. The card reader described in Japanese Unexamined Patent Application Publication No. 2012-118689 includes a card detector that detects insertion of a card into a card insertion slot, a magnetic sensor for detecting a magnetic stripe (a pre-head) that detects a magnetic stripe on the card inserted into the card insertion slot, and a magnetic head that reads magnetic information from the magnetic stripe. The card reader also includes a card conveying passage that extends from the card insertion slot through a magnetic stripe detection position of the magnetic sensor for detecting a magnetic stripe and a magnetic processing position of the magnetic head in this order and a conveying mechanism that conveys the card in a first direction from the card insertion slot toward the magnetic processing position and in a second direction opposite to the first direction, along the card conveying passage. The card reader also includes a shutter that is disposed between the magnetic stripe detection position and the magnetic processing position in the card conveying passage and a shutter moving mechanism that moves the shutter between a closed position where the card conveying passage is closed and an open position where the card conveying passage is opened.

When the card reader described in Japanese Unexamined Patent Application Publication No. 2012-118689 is in a standby state where a card has not entered the card reader, the shutter is at the closed position and closes the card conveying passage. When the card detector detects insertion of the card into the card insertion slot, upon detection of a magnetic stripe on the card based on a signal from the magnetic sensor for detecting a magnetic stripe, the shutter is moved to the open position to open the card conveying passage. The conveying mechanism is then driven and the card is conveyed along the card conveying passage in the first direction and passes through the magnetic processing position. At the magnetic processing position, the magnetic head reads magnetic information from the magnetic stripe. When the magnetic processing operation ends, the card is conveyed in the second direction to be ejected from the card insertion slot.

Japanese Unexamined Patent Application Publication No. 2003-337922 describes a card reader that performs processing on a card including a magnetic stripe and an IC chip. The card reader described in Japanese Unexamined Patent Application Publication No. 2003-337922 includes a metal sensor for detecting an IC chip (a magnetic differential entrance sensor) that detects whether contact terminals of the IC chip on a surface of the card are present, and an IC contact block that communicates with the IC chip. The card reader also includes a card conveying passage that extends from a card insertion slot through an IC chip detection position of the metal sensor for detecting an IC chip and a communication position of the IC contact block in this order and a conveying mechanism that conveys the card in a first direction from the card insertion slot toward the communication position and in a second direction opposite to the first direction along the card conveying passage. The card reader also includes a shutter that is disposed between the IC chip detection position and the communication position in the card conveying passage and a shutter moving mechanism that moves the shutter between a closed position where the card conveying passage is closed and an open position where the card conveying passage is opened.

When the card reader described in Japanese Unexamined Patent Application Publication No. 2003-337922 is in a standby state where a card has not entered the card reader, the shutter is at the closed position and closes the card conveying passage. When the card detector detects insertion of the card into the card insertion slot, upon detection of an IC chip based on a signal from the metal sensor for detecting an IC chip, the shutter is moved to the open position to open the card conveying passage. The conveying mechanism is then driven and the card is conveyed along the card conveying passage in the first direction and passes through the communication position. At the communication position, the IC contact block communicates with the IC chip. When the communication operation ends, the card is conveyed in the second direction to be ejected from the card insertion slot.

In conventional card readers, there has not been proposed a control method of detecting a defect in a magnetic sensor for detecting a magnetic stripe that detects whether a magnetic stripe is present and a defect in a metal sensor for detecting an IC chip.

### SUMMARY

At least an embodiment of the invention provides a control method of a card reader that can detect a defect in a magnetic sensor for detecting a magnetic stripe that detects whether a card has a magnetic stripe, and the card reader. Another object of the invention is to provide a control method of a card reader that can detect a defect in a metal sensor for detecting an IC chip that detects whether a card has an IC chip, and the card reader.

In order to solve the above problems, at least an embodiment of the present invention provides a control method of a card reader, the card reader including a magnetic sensor for detecting a magnetic stripe that detects a magnetic stripe on a card inserted into a card insertion slot, a magnetic head that performs a magnetic processing operation that is at least one of reading magnetic information from the magnetic stripe and writing magnetic information in the magnetic stripe, a card conveying passage that extends from the card insertion slot through a magnetic stripe detection position of the magnetic sensor for detecting a magnetic stripe and a magnetic processing position of the magnetic head in this order, and a conveyance mechanism that conveys the card in a first direction from the card insertion slot toward the magnetic processing position and in a second direction opposite to the first direction along the card conveying passage, when the magnetic stripe is detected based on a signal from the magnetic sensor for detecting a magnetic stripe, the card is conveyed in the first direction by the conveyance mechanism to be subjected to the magnetic processing operation while passing through the magnetic processing position, and the card is then conveyed in the second direction to be ejected from the card insertion slot, wherein at a predetermined timing set in advance, regardless of whether the magnetic stripe is detected, the card inserted into the card insertion slot is conveyed in the first direction to be subjected to the magnetic processing operation while passing through the magnetic processing position and then is conveyed in the second direction to be ejected from the card insertion slot, and when the magnetic stripe is detected based on a signal from the magnetic head in the magnetic processing operation but is not detected based on a signal from the magnetic sensor for detecting a magnetic stripe, it is determined that an abnormality occurs in the magnetic sensor for detecting a magnetic stripe.

According to at least an embodiment of the present invention, at the predetermined timing set in advance, regardless of whether the magnetic stripe is detected based on the signal from the magnetic sensor for detecting a magnetic stripe, the card inserted into the card insertion slot is conveyed in the first direction to pass through the magnetic processing position. The magnetic head then performs the magnetic processing operation on the card at the magnetic processing position. When the magnetic stripe is detected based on the signal from the magnetic head in the magnetic processing operation, the card has the magnetic stripe. Consequently, when the magnetic stripe is detected in the magnetic processing operation but is not detected based on the signal from the magnetic sensor for detecting a magnetic stripe while the card is conveyed in the second direction to pass through the magnetic stripe detection position and ejected from the card insertion slot, it is determined that an abnormality occurs in the magnetic sensor for detecting a magnetic stripe.

According to at least an embodiment of the present invention, when the magnetic stripe is not detected based on a signal from the magnetic head in the magnetic processing operation but is detected based on a signal from the magnetic sensor for detecting a magnetic stripe, it is desirably determined that an abnormality occurs in the magnetic sensor for detecting a magnetic stripe. That is, when the magnetic stripe is not detected based on the signal from the magnetic head in the magnetic processing operation, the card does not have the magnetic stripe at a position opposing the magnetic head. Consequently, when the magnetic stripe is not detected in the magnetic processing operation but is detected based on the signal from the magnetic sensor for detecting a magnetic stripe while the car is conveyed in the second direction to pass through the magnetic stripe detection position and ejected from the card insertion slot, it is possible to determine that an abnormality occurs in the magnetic sensor for detecting a magnetic stripe.

According to at least an embodiment of the present invention, when the magnetic stripe is not detected based on a signal from the magnetic head in the magnetic processing operation and then is not detected based on a signal from the magnetic sensor for detecting a magnetic stripe, it is desirably informed that a position of the card is not correct. In such a case, it is assumed that the position of the card inserted into the card insertion slot is not a reference position set in advance. That is, the card is upside down or back to front with respect to the reference position and thus magnetism of the magnetic stripe cannot be sensed by the magnetic sensor for detecting a magnetic stripe or the magnetic head. Consequently, it is possible to inform that the position of the card is not correct and to prompt an operator who has inserted the cart into the card insertion slot to insert the card at the reference position.

According to at least an embodiment of the present invention, when the magnetic stripe is detected based on a signal from the magnetic head in the magnetic processing operation and then is detected based on a signal from the magnetic sensor for detecting a magnetic stripe, it is desirably determined that the magnetic sensor for detecting a magnetic stripe is normal. That is, when the magnetic stripe is detected based on the signal from the magnetic head in the magnetic processing operation, the card has the magnetic stripe. Consequently, after the magnetic processing operation, when the magnetic stripe is detected based on the signal from the magnetic sensor for detecting a magnetic stripe while the card is conveyed in the second direction to pass through the magnetic stripe detection position and ejected from the card insertion slot, it is possible to determine that the magnetic sensor for detecting a magnetic stripe is normal.

According to at least an embodiment of the present invention, when it is determined that an abnormality occurs in the magnetic sensor for detecting a magnetic stripe, the abnormality is desirably notified to a communicably connected external device. Consequently, when the card reader is connected to the external device, an abnormality in the card reader can be detected by the external device.

According to at least an embodiment of the present invention, the card reader desirably includes in advance a shutter that opens and closes the card conveying passage between the magnetic stripe detection position and the magnetic processing position, the shutter is closed, when the card is inserted into the card insertion slot at the predetermined timing, the shutter is desirably opened, and when it is determined that the magnetic sensor for detecting a magnetic stripe is normal and then the card is inserted into the card insertion slot, in a case where the magnetic stripe is detected based on a signal from the magnetic sensor for detecting a magnetic stripe, the shutter is desirably opened and in a case where the magnetic stripe is not detected based on a signal from the magnetic sensor for detecting a magnetic stripe, the shutter desirably is kept closed. That is, when it is determined that the magnetic sensor for detecting a magnetic stripe is normal and then the magnetic stripe is detected based on the signal from the magnetic sensor for detecting a magnetic stripe, the shutter is opened for the purpose of conveying the card. It is thus possible to prevent the card in a position different from the reference position from being conveyed along the card conveying passage.

According to at least an embodiment of the present invention, the card reader desirably includes in advance a metal sensor for detecting an IC chip that detects an IC chip on the card inserted into the card insertion slot and an IC contact block that performs a communication operation with the IC chip, an IC chip detection position of the metal sensor for detecting an IC chip and a communication position of the IC contact block are set in this order on the card conveying passage from the card insertion slot toward a downstream side in a first direction, at the predetermined timing, the card inserted into the card insertion slot is conveyed in the first direction to be subjected to the magnetic processing operation while passing through the magnetic processing position and to the communication operation at the communication position, and the card is then conveyed in the second direction to be ejected from the card insertion slot, and when communication between the IC contact block and the IC chip is successful in the communication operation but the IC chip is not detected based on a signal from the metal sensor for detecting an IC chip, it is desirably determined that an abnormality occurs in the metal sensor for detecting an IC chip. That is, when communication between the IC contact block and the IC chip is successful in the communication operation, the card has the IC chip. Consequently, when communication is successful but the IC chip is not detected based on the signal from the metal sensor for detecting an IC chip while the card is conveyed in the second direction to pass through the IC chip detection position and ejected from the card insertion slot, it is possible to determine that an abnormality occurs in the metal sensor for detecting an IC chip.

According to at least an embodiment of the present invention, when communication between the IC contact block and the IC chip fails in the communication operation but the IC chip is detected based on a signal from the metal sensor for detecting an IC chip, it is desirably determined that an abnormality occurs in the metal sensor for detecting an IC chip. That is, when the IC contact block cannot communicate with the IC chip in the communication operation, the card does not have the IC chip. Consequently, when communication fails but the IC chip is detected based on the signal from the metal sensor for detecting an IC chip while the card is conveyed in the second direction to pass through the IC chip detection position, it is possible to determine that an abnormality occurs in the metal sensor for detecting an IC chip.

Next, at least an embodiment of the present invention provides a control method of a card reader, the card reader including a metal sensor for detecting an IC chip that detects an IC chip on a card inserted into a card insertion slot, an IC contact block that performs a communication operation with the IC chip, a card conveying passage that extends from the card insertion slot through an IC chip detection position of the metal sensor for detecting an IC chip and a communication position of the IC contact block in this order, and a conveyance mechanism that conveys the card in a first direction from the card insertion slot toward the communication position and in a second direction opposite to the first direction along the card conveying passage, when the IC chip is detected based on a signal from the metal sensor for detecting an IC chip, the card is conveyed in the first direction by the conveyance mechanism to be subjected to the communication operation at the communication position, and the card is then conveyed in the second direction to be ejected from the card insertion slot, wherein at a predetermined timing set in advance, regardless of whether the IC chip is detected, the card inserted into the card insertion slot is conveyed in the first direction to be subjected to the communication operation at the communication position and then is conveyed in the second direction to be ejected from the card insertion slot, and when communication between the IC contact block and the IC chip is successful in the communication operation but the IC chip is not detected based on a signal from the metal sensor for detecting an IC chip, it is determined that an abnormality occurs in the magnetic sensor for detecting a magnetic stripe.

According to at least an embodiment of the present invention, at the predetermined timing set in advance, regardless of whether the IC chip is detected based on the signal from the metal sensor for detecting an IC chip, the card inserted into the card insertion slot is conveyed in the first direction to pass through the communication position. The IC contact block then performs the communication operation on the card at the communication position. When communication between the IC chip and the IC contact block is successful in the communication operation, the card has the IC chip. Consequently, when communication is successful in the communication operation but the IC chip is not detected based on the signal from the metal sensor for detecting an IC chip while the card is conveyed in the second direction to pass through the IC chip detection position and ejected from the card insertion slot, it is possible to determine that an abnormality occurs in the metal sensor for detecting an IC chip.

According to at least an embodiment of the present invention, when communication between the IC contact block and the IC chip fails in the communication operation but the IC chip is detected based on a signal from the metal sensor for detecting an IC chip, it is desirably determined that an abnormality occurs in the metal sensor for detecting an IC chip. That is, when communication between the IC chip and the IC contact block fails in the communication operation, the card does not have the IC chip at the position opposing the IC contact block. Consequently, when communication fails in the communication operation but the IC chip is detected based on the signal from the metal sensor for detecting an IC chip while the card is conveyed in the second direction to pass through the IC chip detection position and ejected from the card insertion slot, it is possible to determine that an abnormality occurs in the metal sensor for detecting an IC chip.

Next, a card reader according to at least an embodiment of the present invention includes a card detector that detects insertion of a card into a card insertion slot, a magnetic sensor for detecting a magnetic stripe that detects a magnetic stripe on the card inserted into the card insertion slot, a magnetic head that performs a magnetic processing operation that is at least one of reading magnetic information from the magnetic stripe and writing magnetic information in the magnetic stripe, a card conveying passage that extends from the card insertion slot through a magnetic stripe detection position of the magnetic sensor for detecting a magnetic stripe and a magnetic processing position of the magnetic head in this order, a conveyance mechanism that conveys the card in a first direction from the card insertion slot toward the magnetic processing position and in a second direction opposite to the first direction along the card conveying passage, a storage unit, a magnetic stripe detection unit that detects whether the card has the magnetic stripe based on a signal from the magnetic sensor for detecting a magnetic stripe, a first conveyance control unit that, when insertion of the card into the card insertion slot is detected and the magnetic stripe detection unit detects the magnetic stripe, drives the conveyance mechanism to convey the card in the first direction to cause the card to pass through the magnetic processing position and then conveys the card in the second direction to eject the card from the card insertion slot, a second conveyance control unit, where when insertion of the card into the card insertion slot is detected at a predetermined timing set in advance, the second conveyance control unit drives the conveyance mechanism regardless of whether the magnetic stripe detection unit detects the magnetic stripe to convey the card in the first direction to cause the card to pass through the magnetic processing position and then conveys the card in the second direction to eject the card from the card insertion slot, a magnetic head control unit that drives the magnetic head to perform the magnetic processing operation on the card passing through the magnetic processing position, a determination storage unit that determines whether the card has the magnetic stripe based on a signal from the magnetic head in the magnetic processing operation, and stores and holds a determination result in the storage unit, and an abnormality determination unit that determines that an abnormality occurs in the magnetic sensor for detecting a magnetic stripe when the magnetic stripe detection unit does not detect the magnetic stripe in a state where the determination result that the card has the magnetic stripe is stored in the storage unit.

According to at least an embodiment of the present invention, at the predetermined timing set in advance, regardless of whether the magnetic stripe is detected based on the signal from the magnetic sensor for detecting a magnetic stripe, the second conveyance control unit conveys the card inserted into the card insertion slot in the first direction to cause the card to pass through the magnetic processing position. When the magnetic head performs the magnetic processing operation on the card at the magnetic processing position, the determination storage unit determines whether the card has the magnetic stripe based on the signal from the magnetic head in the magnetic processing operation, and stores and holds a determination result in the storage unit.

When the magnetic stripe is detected based on the signal from the magnetic head in the magnetic processing operation, the card has the magnetic stripe. The determination storage unit thus stores the determination result that the card has the magnetic stripe in the storage unit. Consequently, when the magnetic stripe detection unit does not detect the magnetic stripe in a state where the determination result that the card has the magnetic stripe is stored in the storage unit, the abnormality determination unit can determine that an abnormality occurs in the magnetic sensor for detecting a magnetic stripe.

According to at least an embodiment of the present invention, the abnormality determination unit desirably determines that an abnormality occurs in the magnetic sensor for detecting a magnetic stripe when the magnetic stripe detection unit detects the magnetic stripe in a state where the determination result that the card does not have the magnetic stripe is stored in the storage unit. That is, when the magnetic stripe is not detected based on the signal from the magnetic head in the magnetic processing operation, the card does not have the magnetic stripe. Consequently, when the magnetic stripe detection unit detects the magnetic stripe in a state where the determination result that the card does not have the magnetic stripe is stored in the storage unit, the abnormality determination unit can determine that an abnormality occurs in the magnetic sensor for detecting a magnetic stripe.

The card reader according to at least an embodiment of the present invention desirably further includes an informing unit that informs an upper-level device that a position of the card is not correct when the magnetic stripe detection unit does not detect the magnetic stripe in a state where the determination result that the card does not have the magnetic stripe is stored in the storage unit. In such a case, it is assumed that the position of the card inserted into the card insertion slot is not the reference position set in advance. That is, the card is upside down or back to front with respect to the reference position and thus magnetism of the magnetic stripe cannot be sensed by the magnetic sensor for detecting a magnetic stripe or the magnetic head. Consequently, it is possible to inform that the position of the card is not correct and to prompt an operator who has inserted the cart into the card insertion slot to insert the card at the reference position.

According to at least an embodiment of the present invention, the abnormality determination unit desirably determines that the magnetic sensor for detecting a magnetic stripe is normal when the magnetic stripe detection unit detects the magnetic stripe in a state where the determination result that the card has the magnetic stripe is stored in the storage unit. That is, when the magnetic stripe is detected based on the signal from the magnetic head in the magnetic processing operation, the card has the magnetic stripe. Consequently, when the magnetic stripe detection unit detects the magnetic stripe in a state where the determination result that the card has the magnetic stripe is stored in the storage unit, the abnormality determination unit can determine that the magnetic sensor for detecting a magnetic stripe is normal.

At least an embodiment of the present invention desirably further includes a notification unit that, when the abnormality determination unit determines that an abnormality occurs in the magnetic sensor for detecting a magnetic stripe, notifies a communicably connected external device of the abnormality. When the card reader is connected to the external device, an abnormality in the card reader can be detected by the external device.

The card reader according to at least an embodiment of the present invention desirably further includes a shutter that opens and closes the card conveying passage between the magnetic stripe detection position and the magnetic processing position, a shutter movement mechanism that moves the shutter between a closed position where the card conveying passage is closed and an open position where the card conveying passage is opened, and a shutter control unit that drives the shutter movement mechanism to move the shutter at the closed position to the open position when insertion of the card into the card insertion slot is detected at the predetermined timing, wherein when it is determined that the magnetic sensor for detecting a magnetic stripe is normal and then insertion of the card into the card insertion slot is detected, if the magnetic stripe is detected based on a signal from the magnetic sensor for detecting a magnetic stripe, the shutter control unit drives the shutter movement mechanism to move the shutter at the closed position to the open position, and if the magnetic stripe is not detected based on a signal from the magnetic sensor for detecting a magnetic stripe, the shutter control unit keeps the shutter at the closed position. That is, when it is determined that the magnetic sensor for detecting a magnetic stripe is normal and then the magnetic stripe is detected based on the signal from the magnetic sensor for detecting a magnetic stripe, the shutter is opened for the purpose of conveying the card. It is thus possible to prevent the card in a position different from the reference position from being conveyed along the card conveying passage.

According to at least an embodiment of the present invention, the card reader desirably further includes a metal sensor for detecting an IC chip that detects an IC chip on the card inserted into the card insertion slot, an IC contact block that performs a communication operation with the IC chip, an IC chip detection unit that detects the IC chip based on a signal from the metal sensor for detecting an IC chip, an IC contact block control unit that drives the IC contact block to perform a communication operation with the IC chip and obtains a communication result whether communication is successful, and a communication result storage unit that stores a communication result whether communication between the IC chip and the IC contact block is successful in the storage unit, wherein the card conveying passage extends from the card insertion slot toward a downstream side in a first direction through an IC chip detection position of the metal sensor for detecting an IC chip and a communication position of the IC contact block, when the IC chip detection unit detects the IC chip, the first conveyance control unit drives the conveyance mechanism to convey the card in the first direction to cause the card to pass through the IC chip detection position and the communication position and then conveys the card in the second direction to eject the card from the card insertion slot, the second conveyance control unit drives the conveyance mechanism regardless whether the IC chip detection unit detects the IC chip to convey the card in the first direction to cause the card to pass through the IC chip detection position and the communication position and then conveys the card in a second direction to eject the card from the card insertion slot, and wherein the abnormality determination unit determines that an abnormality occurs in the metal sensor for detecting an IC chip when the IC chip detection unit does not detect the IC chip in a state where the communication result that communication is successful is stored in the storage unit. That is, when communication is successful in the communication operation, the card has the IC chip. The abnormality determination unit can thus determine that an abnormality occurs in the metal sensor for detecting an IC chip when the IC chip detection unit does not detect the IC chip in a state where the communication result that communication is successful is stored in the storage unit.

According to at least an embodiment of the present invention, the abnormality determination unit desirably determines that an abnormality occurs in the metal sensor for detecting an IC chip when the IC chip detection unit detects the IC chip in a state where the communication result that communication fails is stored in the storage unit. That is, when communication fails in the communication operation, the card does not have the IC chip. The abnormality determination unit can thus determine that an abnormality occurs in the metal sensor for detecting an IC chip when the IC chip detection unit detects the IC chip in a state where the communication result that communication fails is stored in the storage unit.

Next, according to another aspect of at least an embodiment of the present invention, there is provided a card reader including a card detector that detects insertion of a card into a card insertion slot, a metal sensor for detecting an IC chip that detects an IC chip on the card inserted into the card insertion slot, an IC contact block that performs a communication operation with the IC chip, a card conveying passage that extends from the card insertion slot through an IC chip detection position of the metal sensor for detecting an IC chip and a communication position of the IC contact block in this order, a conveyance mechanism that conveys the card in a first direction from the card insertion slot toward the communication position and in a second direction opposite to the first direction along the card conveying passage, a storage unit, an IC chip detection unit that detects the IC chip based on a signal from the metal sensor for detecting an IC chip, a first conveyance control unit that, when insertion of the card into the card insertion slot is detected and the IC chip detection unit detects the IC chip, drives the conveyance mechanism to convey the card in the first direction to cause the card to pass through the communication position and then conveys the card in the second direction to eject the card from the card insertion slot, a second conveyance control unit, where when insertion of the card into the card insertion slot is detected at a predetermined timing set in advance, the second conveyance control unit drives the conveyance mechanism regardless of whether the IC chip detection unit detects the IC chip to convey the card in the first direction to cause the card to pass through the communication position and then conveys the card in the second direction to eject the card from the card insertion slot, an IC contact block control unit that drives the IC contact block to perform the communication operation with the IC chip and obtains a communication result whether communication is successful, a communication result storage unit that stores and holds a communication result whether communication is successful in the storage unit, and an abnormality determination unit that determines that an abnormality occurs in the metal sensor for detecting an IC chip when the IC chip detection unit does not detect the IC chip in a state where the communication result that the communication is successful is stored in the storage unit.

According to at least an embodiment of the present invention, at the predetermined timing set in advance, regardless of whether the IC chip is detected based on the signal from the metal sensor for detecting an IC chip, the card inserted into the card insertion slot is conveyed in the first direction to pass through the communication position. The IC contact block then performs the communication operation on the card at the communication position. When the IC chip is detected based on the signal from the IC contact block, the card has the IC chip. Consequently, when the IC chip is detected in the communication operation but is not detected based on the signal from the metal sensor for detecting an IC chip while the card is conveyed in the second direction to pass through the IC chip detection position and ejected from the card insertion slot, it is possible to determine that an abnormality occurs in the metal sensor for detecting an IC chip.

According to at least an embodiment of the present invention, the abnormality determination unit desirably determines that an abnormality occurs in the metal sensor for detecting an IC chip when the IC chip detection unit detects the IC chip in a state where the communication result that the communication fails is stored in the storage unit. That is, when communication fails in the communication operation, the card does not have the IC chip. The abnormality determination unit can thus determine that an abnormality occurs in the metal sensor for detecting an IC chip when the IC chip detection unit detects the IC chip in a state where the communication result that communication fails is stored in the storage unit.

According to the control method of a card reader and the card reader of at least an embodiment of the present invention, it is possible to determine whether a defect is present in the magnetic sensor for detecting a magnetic stripe that detects a magnetic stripe on a card. In addition, according to the control method of a card reader and the card reader of at least an embodiment of the present invention, it is possible to determine whether a defect is present in the metal sensor for detecting an IC chip that detects an IC chip on a card.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory diagram of a card reader to which at least an embodiment of the present invention is applied as viewed from the side;

FIG. 2 is an explanatory diagram of a card, which is a process target of the card reader;

FIG. 3 is a schematic block diagram of a control system of the card reader;

FIG. 4 is a flowchart of a normal operation of the card reader;

FIG. 5 is a flowchart of an operation of the card reader at a predetermined timing;

FIG. 6 is a flowchart of an operation of determining an abnormality in a magnetic sensor for detecting a magnetic stripe; and

FIG. 7 is a flowchart of an operation of determining an abnormality in a metal sensor for detecting an IC chip.

### DETAILED DESCRIPTION

Embodiments of a card reader to which the present invention is applied will now be described with reference to the drawings.

### (Card Reader)

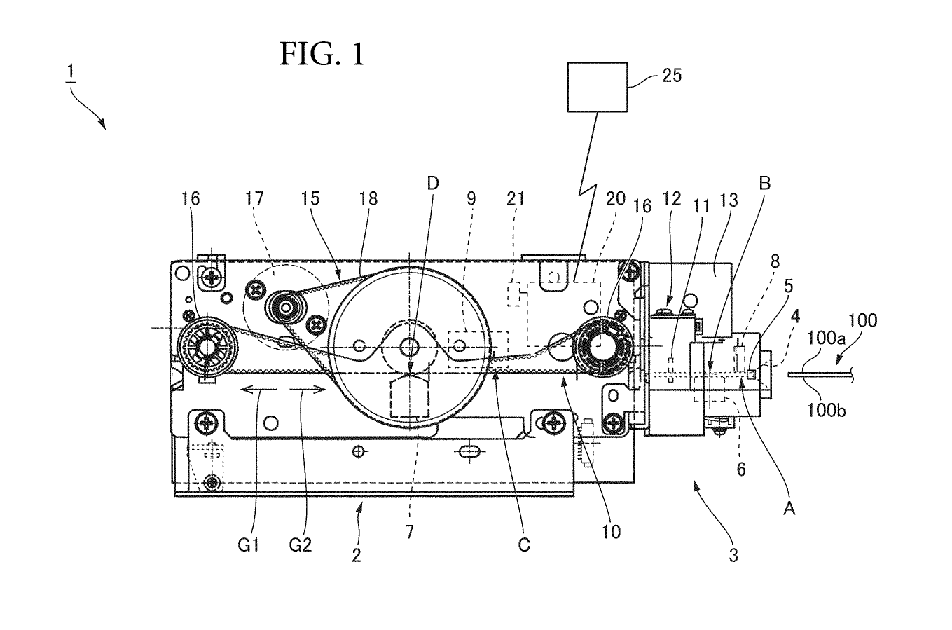

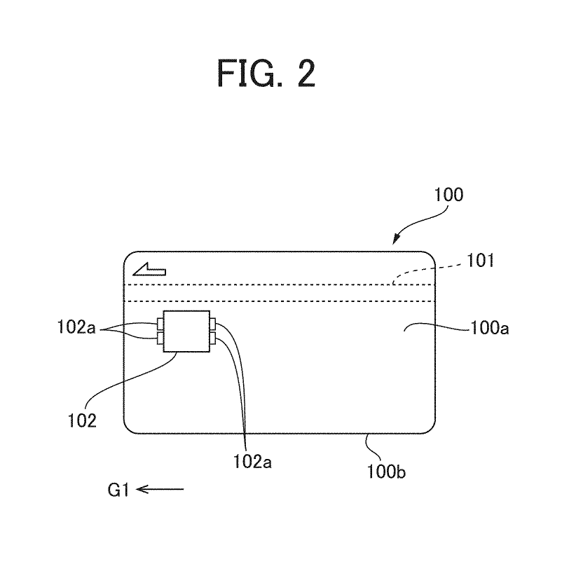

FIG. 1 is an explanatory diagram of a card reader to which at least an embodiment of the present invention is applied as viewed from the side. FIG. 2 is an explanatory diagram of a card processed by the card reader. A card reader 1 according to the present embodiment performs processing on a card 100 including a magnetic stripe 101 and an IC chip 102. That is, the card reader 1 performs a magnetic processing operation, that is, at least one of reading information from the magnetic stripe 101 on the card 100 and writing information in the magnetic stripe 101. The card reader 1 also communicates with the IC chip 102 on the card 100.

The card 100 is commonly formed in a rectangular plate shape with a thickness of approximately 0.7 mm to 0.8 mm. As shown in FIG. 2, the card 100 includes the IC chip 102 and contact terminals 102a for communicating with the IC chip 102 on a front surface 100a. The IC chip 102 and the contact terminals 102a are placed to be closer to one side of the card 100 in a transverse direction with respect to the center thereof. The card 100 also includes the magnetic stripe 101 on a rear surface 100b. The magnetic stripe 101 is placed to be closer to the one side of the card 100 in the transverse direction with respect to the center thereof.

As shown in FIG. 1, the card reader 1 includes a card reader main body 2 and a card insertion part 3 at the front end of the card reader main body 2. A card insertion slot 4 is formed in the front surface of the card insertion part 3.

The card reader 1 includes a card detector 5 that detects insertion of the card 100 into the card insertion slot 4, a magnetic sensor 6 for detecting a magnetic stripe that detects the magnetic stripe 101 on the card 100 inserted into the card insertion slot 4, and a magnetic head 7 that performs a magnetic processing operation on the magnetic stripe 101. The card reader 1 also includes a metal sensor 8 for detecting an IC chip that detects the IC chip 102 on the card 100 inserted into the card insertion slot 4 and an IC contact block 9 that communicates with the IC chip 102.

The card detector 5 is a switch that mechanically detects the card 100 inserted into the card insertion slot 4. When the card 100 inserted into the card insertion slot 4 has a predetermined width, the card detector 5 contacts the card 100 to operate. In operation, the card detector 5 detects insertion of the card 100 into the card insertion slot 4. The metal sensor 8 for detecting an IC chip detects the contact terminals 102a of the IC chip 102 on the card 100. That is, when the card 100 is inserted into the card insertion slot 4, the metal sensor 8 for detecting an IC chip detects a change in magnetic field due to the metallic contact terminals 102a and outputs a signal corresponding to the change in magnetic field. When the card 100 is inserted into the card insertion slot 4, the magnetic sensor 6 for detecting a magnetic stripe detects a change in magnetic field due to the magnetic stripe 101 and outputs a signal corresponding to the change in magnetic field.

The card reader 1 also includes a card conveying passage 10 that extends from the card insertion slot 4 to the interior of the card reader main body 2. The card conveying passage 10 extends from the card insertion slot 4 toward the card reader main body 2 through an IC chip detection position A of the metal sensor 8 for detecting an IC chip, a magnetic stripe detection position B of the magnetic sensor 6 for detecting a magnetic stripe, a communication position C of the IC contact block 9 with the IC chip 102, and a magnetic processing position D of the magnetic head 7 on the magnetic stripe 101 in this order. The card reader 1 also includes a shutter 11 that opens and closes the card conveying passage 10 between the magnetic stripe detection position B and the communication position C and a shutter moving mechanism 12 that moves the shutter 11 between a closed position where the card conveying passage 10 is closed and an open position where the card conveying passage 10 is opened. In the present embodiment, the open position is below the card conveying passage 10, and the shutter 11 moves upward from the open position to the closed position where the card conveying passage 10 is closed. The shutter moving mechanism 12 includes a solenoid 13 as a drive source.

The card reader 1 also includes a conveyance mechanism 15 that conveys the card 100 along the card conveying passage 10. The conveyance mechanism 15 includes a plurality of conveyance rollers 16, a conveyance motor 17, and a drive transmission mechanism 18 that transmits the rotation of the conveyance motor 17 to each conveyance roller 16. The conveyance motor 17 is a drive source of the conveyance mechanism 15. The conveyance mechanism 15 conveys the card 100 in a first direction G1 from the card insertion slot 4 toward the card reader main body 2 (the magnetic processing position D and the communication position C) and in a second direction G2 opposite to the first direction G1.

The metal sensor 8 for detecting an IC chip is disposed on the card conveying passage 10. The magnetic sensor 6 for detecting a magnetic stripe is disposed under the card conveying passage 10. The metal sensor 8 for detecting an IC chip is thus disposed to be opposite to the magnetic sensor 6 for detecting a magnetic stripe with the card conveying passage 10 being provided therebetween. Such arrangement is based on the fact that the contact terminals 102a of the IC chip 102 are on the front surface 100a of the card 100 and the magnetic stripe 101 is on the rear surface 100b of the card 100. The metal sensor 8 for detecting an IC chip is disposed such that when the card 100 in a reference position is inserted into the card conveying passage 10, a sensor surface of the metal sensor 8 for detecting an IC chip opposes a position through which the contact terminals 102a pass. The magnetic sensor 6 for detecting a magnetic stripe is disposed to oppose the magnetic stripe 101 on the card 100 when the card 100 in a reference position is inserted into the card insertion slot 4. The reference position is determined such that the front surface 100a of the card 100 having the IC chip 102 (the contact terminals 102a) thereon faces upward and the IC chip 102 (the contact terminals 102a) on the card 100 is disposed at the front (on a downstream side) in the first direction G1, as shown in FIG. 2.

The card reader 1 also includes a control unit 20 including a CPU, a ROM, and a RAM and a storage unit 21 that is communicably connected to the control unit 20. The card detector 5, the magnetic sensor 6 for detecting a magnetic stripe, and the metal sensor 8 for detecting an IC chip are connected to the control unit 20. The magnetic head 7, the IC contact block 9, the solenoid 13, and the conveyance motor 17 are also connected via a driver (not shown) to the control unit 20. An upper-level device 25 such as a computer is also communicably connected via a communication interface (not shown) to the control unit 20.

### (Control Unit)

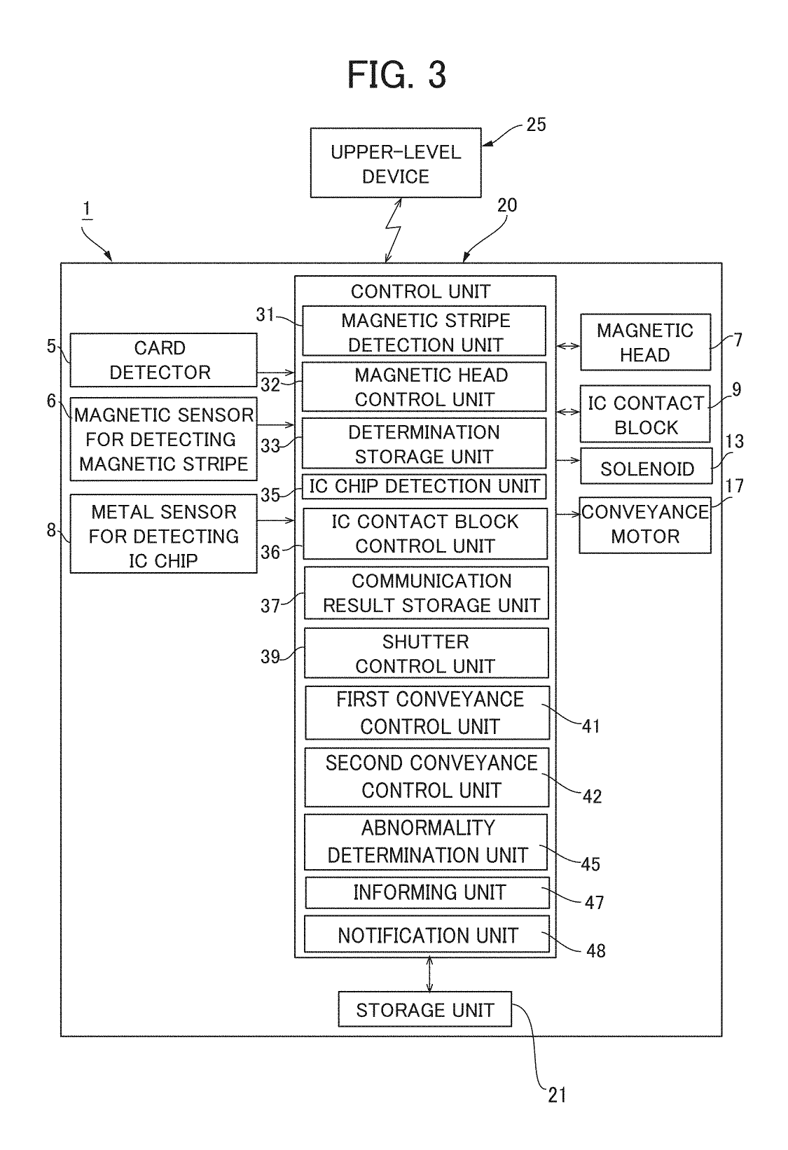

FIG. 3 is a schematic block diagram of a control system of the card reader 1. The control unit 20 includes a magnetic stripe detection unit 31, a magnetic head control unit 32, a determination storage unit 33, an IC chip detection unit 35, an IC contact block control unit 36, a communication result storage unit 37, a shutter control unit 39, a first conveyance control unit 41, a second conveyance control unit 42, an abnormality determination unit 45, an informing unit 47, and a notification unit 48.

The magnetic stripe detection unit 31 detects whether the magnetic stripe 101 is present based on a signal from the magnetic sensor 6 for detecting a magnetic stripe. The magnetic head control unit 32 drives the magnetic head 7 to perform a magnetic processing operation on the card 100 passing through the magnetic processing position D.

The determination storage unit 33 determines whether the magnetic stripe 101 is present based on a signal from the magnetic head 7 in the magnetic processing operation and stores a determination result in the storage unit 21. That is, if the magnetic stripe 101 is present at a position opposing the magnetic head 7 when the magnetic head 7 performs the magnetic processing operation, the signal from the magnetic head 7 includes a signal corresponding to a change in magnetic field due to the magnetic stripe 101. On the other hand, if the magnetic stripe 101 is not present at the position opposing the magnetic head 7 when the magnetic head 7 performs the magnetic processing operation, the signal from the magnetic head 7 does not include the signal corresponding to a change in magnetic field due to the magnetic stripe 101. When the signal from the magnetic head 7 includes the signal corresponding to a change in magnetic field due to the magnetic stripe 101, the determination storage unit 33 determines that the card 100 has the magnetic stripe 101 and stores the determination result that the card 100 has the magnetic stripe 101 in the storage unit 21. On the other hand, the signal from the magnetic head 7 does not include the signal corresponding to a change in magnetic field due to the magnetic stripe 101, the determination storage unit 33 determines that the card 100 does not have the magnetic stripe 101 and stores the determination result that the card 100 does not have the magnetic stripe 101 in the storage unit 21.

The IC chip detection unit 35 detects whether the IC chip 102 is present based on a signal from the metal sensor 8 for detecting an IC chip. The IC contact block control unit 36 drives the IC contact block 9 to communicate with the IC chip 102 and acquires a communication result whether communication is successful. The communication result storage unit 37 stores a communication result whether communication of the IC chip 102 with the IC contact block 9 is successful in the storage unit 21.

The first conveyance control unit 41 drives the conveyance mechanism 15 when insertion of the card 100 into the card insertion slot 4 is detected, the magnetic stripe 101 is detected by the magnetic stripe detection unit 31, and the IC chip 102 is detected by the IC chip detection unit 35. The first conveyance control unit 41 also conveys the card 100 in the first direction G1 to cause the card 100 to pass through the communication position C and the magnetic processing position D, and then conveys the card 100 in the second direction G2 to eject the card 100 from the card insertion slot 4.

The second conveyance control unit 42 drives the conveyance mechanism 15 when insertion of the card 100 into the card insertion slot 4 is detected at a predetermined timing set in advance. The first conveyance control unit 41 conveys the card 100 in the first direction G1 to cause the card 100 to pass through the communication position C and the magnetic processing position D, and then conveys the card 100 in the second direction G2 to eject the card 100 from the card insertion slot 4. That is, the second conveyance control unit 42 drives the conveyance mechanism 15 when insertion of the card 100 into the card insertion slot 4 is detected at the predetermined timing set in advance, regardless of whether the magnetic stripe detection unit 31 detects the magnetic stripe 101. In addition, the second conveyance control unit 42 drives the conveyance mechanism 15 when insertion of the card 100 into the card insertion slot 4 is detected regardless of whether the IC chip detection unit 35 detects the IC chip 102.

The predetermined timing set in advance is a timing when the card reader 1 is installed at a bank or the like and then the card 100 is inserted into the card insertion slot 4 for the first time. Alternatively, the predetermined timing set in advance may be a periodic timing such as every fixed period after the card reader 1 is installed.

The shutter control unit 39 moves the shutter 11 at the closed position to the open position when insertion of the card 100 into the card insertion slot 4 is detected, the magnetic stripe 101 is detected by the magnetic stripe detection unit 31, and the IC chip 102 is detected by the IC chip detection unit 35. When the shutter 11 is moved to the open position to open the card conveying passage 10, the card 100 can be conveyed by the conveyance mechanism 15. Further, the shutter control unit 39 returns the shutter 11 at the open position to the closed position when the card 100 is ejected from the card insertion slot 4. When insertion of the card 100 into the card insertion slot 4 is detected at the predetermined timing, the shutter control unit 39 moves the shutter 11 at the closed position to the open position. When the shutter 11 is moved to the open position to open the card conveying passage 10, the card 100 can be conveyed by the conveyance mechanism 15.

The abnormality determination unit 45 determines whether an abnormality occurs in the magnetic sensor 6 for detecting a magnetic stripe and the metal sensor 8 for detecting an IC chip. That is, the abnormality determination unit 45 determines that an abnormality occurs in the magnetic sensor 6 for detecting a magnetic stripe when the magnetic stripe detection unit 31 does not detect the magnetic stripe 101 in a state where the determination result that the card 100 has the magnetic stripe 101 is stored in the storage unit 21. In addition, the abnormality determination unit 45 determines that an abnormality occurs in the magnetic sensor 6 for detecting a magnetic stripe when the stripe detection unit 31 detects the magnetic stripe 101 in a state where the determination result that the card 100 does not have the magnetic stripe 101 is stored in the storage unit 21. Moreover, the abnormality determination unit 45 determines that the magnetic sensor 6 for detecting a magnetic stripe is normal when the magnetic stripe detection unit 31 detects the magnetic stripe 101 in a state where the determination result that the card 100 has the magnetic stripe 101 is stored in the storage unit 21.

The abnormality determination unit 45 also determines that an abnormality occurs in the metal sensor 8 for detecting an IC chip when the IC chip detection unit 35 does not detect the IC chip 102 in a state where the communication result that communication is successful is stored in the storage unit 21. Further, the abnormality determination unit 45 determines that an abnormality occurs in the metal sensor 8 for detecting an IC chip when the IC chip detection unit 35 detects the IC chip 102 in a state where the communication result that communication fails is stored in the storage unit 21. Moreover, the abnormality determination unit 45 determines that the metal sensor 8 for detecting an IC chip is normal when the IC chip detection unit 35 detects the IC chip 102 in a state where the communication result that communication is successful is stored in the storage unit 21.

The informing unit 47 informs an upper-level device that the position of the card 100 is not correct when the magnetic stripe detection unit 31 does not detect the magnetic stripe 101 in a state where the determination result that the card 100 does not have the magnetic stripe 101 is stored in the storage unit 21. Further, the informing unit 47 informs the upper-level device that the position of the card 100 is not correct when the IC chip detection unit 35 does not detect the IC chip 102 in a state where the communication result that communication fails is stored in the storage unit 21. That is, it is assumed in these cases that the position of the card 100 inserted into the card insertion slot 4 is not the reference position. For example, the card 100 is upside down or back to front with respect to the reference position and thus magnetism of the magnetic stripe 101 cannot be sensed by the magnetic sensor 6 for detecting a magnetic stripe or the magnetic head 7. Alternatively, the card 100 is upside down or back to front with respect to the reference position and thus the contact terminals 102a of the IC chip 102 cannot contact the IC contact block 9, resulting in a communication failure. Alternatively, the card 100 is upside down or back to front with respect to the reference position and thus the IC chip 102 (the contact terminals 102a) cannot be detected by the metal sensor 8 for detecting an IC chip. The informing unit 47 thus informs an operator who has inserted the card 100 into the card insertion slot 4 that the position of the position of the card 100 is not correct and prompts the operator to insert the card 100 at the reference position. In the present embodiment, the informing unit 47 informs the upper-level device 25 that is communicably connected to the control unit 20 that the position of the card 100 is not correct.

When the abnormality determination unit 45 determines that an abnormality occurs in the magnetic sensor 6 for detecting a magnetic stripe, the notification unit 48 notifies the upper-level device 25 that is communicably connected to the control unit 20 of the abnormality. When the abnormality determination unit 45 determines that an abnormality occurs in the metal sensor 8 for detecting an IC chip, the notification unit 48 notifies the upper-level device 25 that is communicably connected to the control unit 20 of the abnormality.

### (Operation of Card Reader)

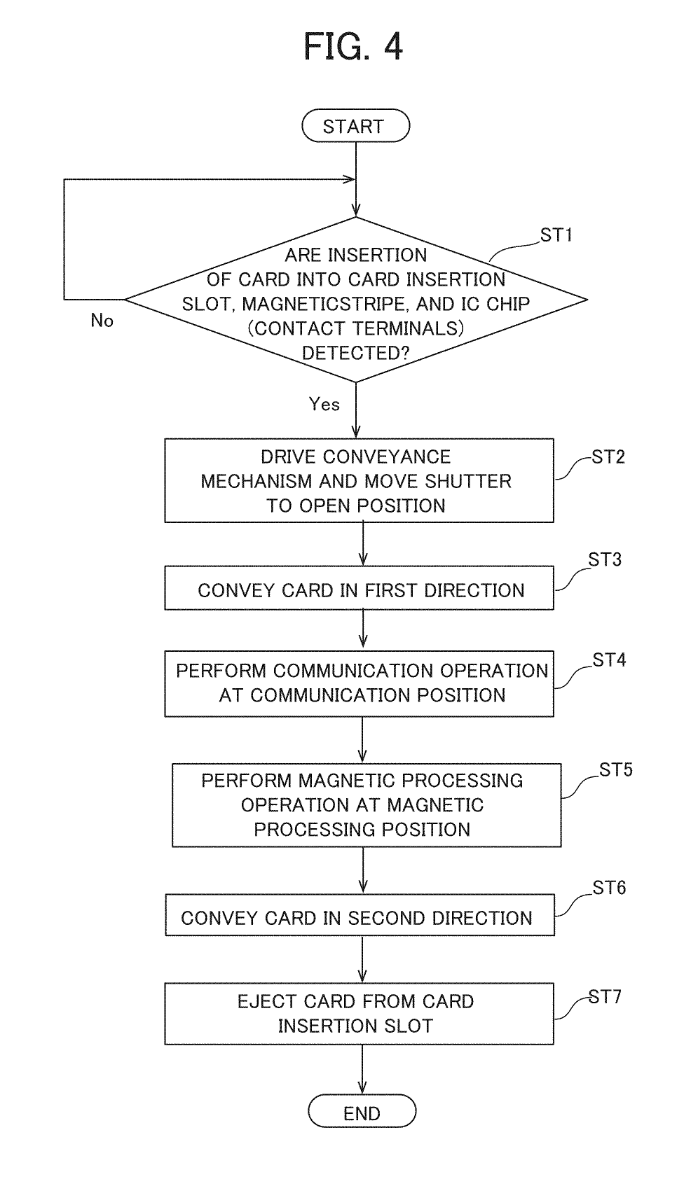

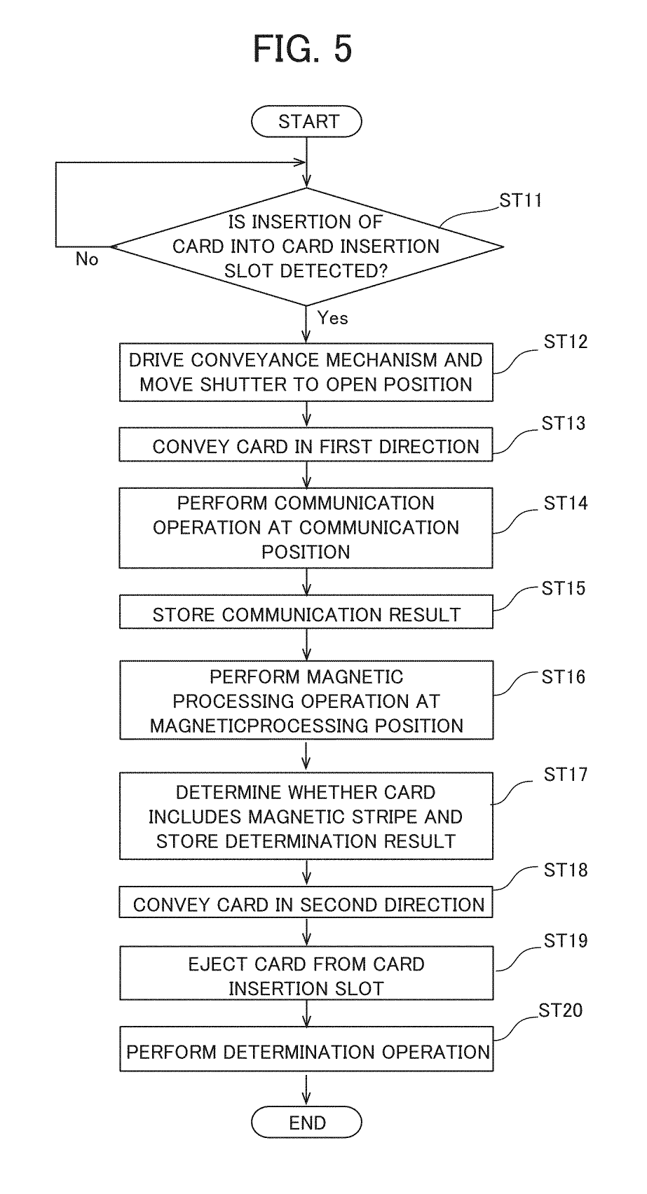

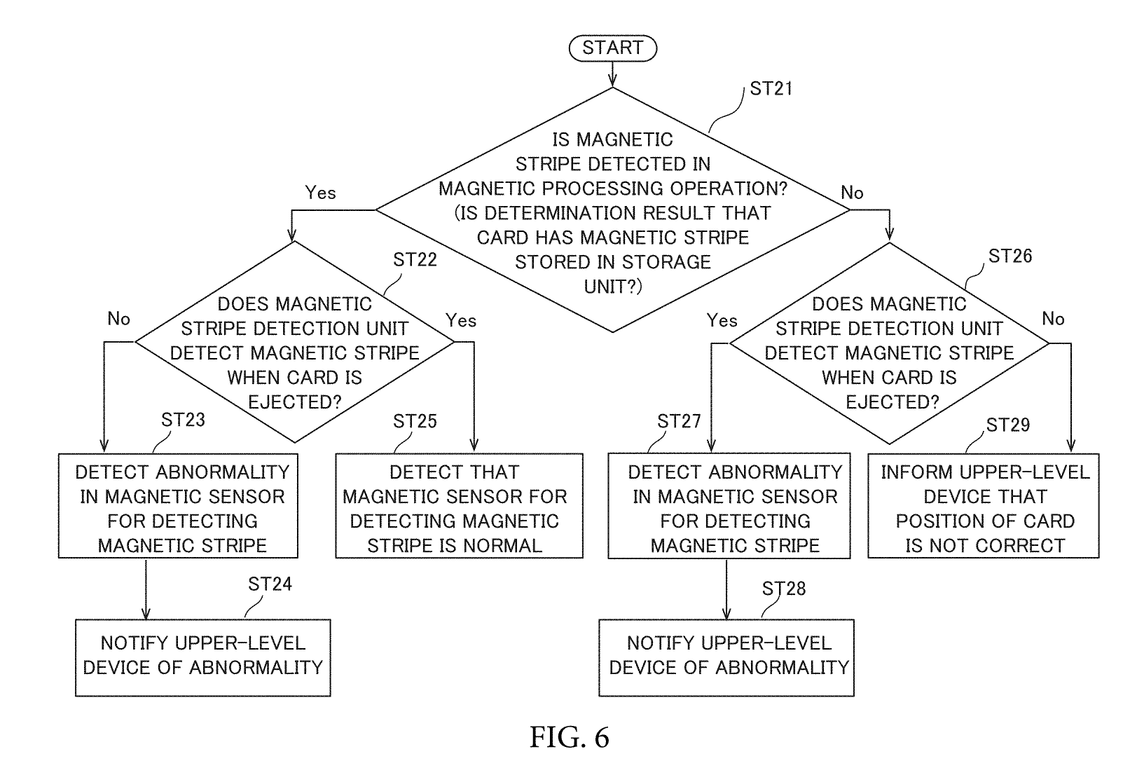

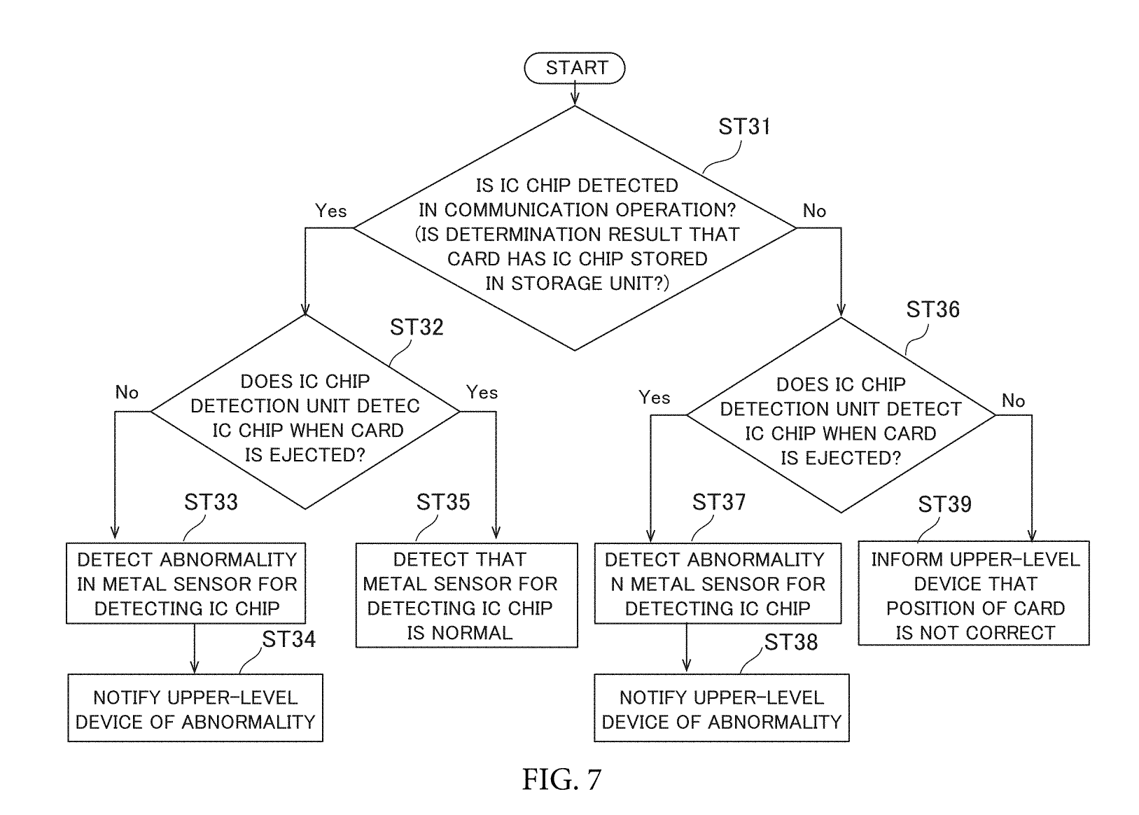

FIG. 4 is a flowchart of a normal operation of the card reader 1. FIG. 5 is a flowchart of an operation of the card reader 1 at a predetermined timing. FIG. 6 is a flowchart of an abnormality determination operation of determining whether a magnetic sensor for detecting a magnetic stripe is normal. FIG. 7 is a flowchart of an abnormality determination operation of determining whether a metal sensor for detecting an IC chip is normal.

As shown in FIG. 4, normally in the card reader 1, when insertion of the card 100 into the card insertion slot 4 is detected by the card detector 5, the magnetic stripe 101 is detected based on a signal from the magnetic sensor 6 for detecting a magnetic stripe, and the IC chip 102 (the contact terminals 102a) is detected based on a signal from the metal sensor 8 for detecting an IC chip (Yes at step ST1), the conveyance mechanism 15 is driven and the shutter 11 is moved from a closed position to an open position (step ST2). The card 100 is thus conveyed in the first direction G1 (step ST3) and passes through the communication position C and the magnetic processing position D. A communication operation is performed at the communication position C (step ST4). A magnetic processing operation is performed at the magnetic processing position D (step ST5). The card 100 is then conveyed in the second direction G2 (step ST6) and ejected from the card insertion slot 4 (step ST7). When the card 100 is ejected from the card insertion slot 4, the card reader 1 returns the shutter 11 to the closed position.

In the normal operation of the card reader 1, when the magnetic stripe 101 is not detected based on the signal from the magnetic sensor 6 for detecting a magnetic stripe or when the IC chip 102 (the contact terminals 102a) is not detected based on the signal from the metal sensor 8 for detecting an IC chip even if insertion of the card 100 into the card insertion slot 4 is detected by the card detector 5 (No at step ST1), the conveyance mechanism 15 is not driven and the shutter 11 is not opened.

On the other hand, in the operation of the card reader 1 at the predetermined timing, which is shown in FIG. 5, when insertion of the card 100 into the card insertion slot 4 is detected by the card detector 5 (Yes at step ST11), the conveyance mechanism 15 is driven and the shutter 11 is moved from the closed position to the open position (step ST12). That is, the conveyance mechanism 15 is driven and the shutter 11 is moved from the closed position to the open position regardless of whether the magnetic stripe 101 is detected by the magnetic stripe detection unit 31 and whether the IC chip 102 is detected by the IC chip detection unit 35.

The card 100 is conveyed in the first direction G1 (step ST13) and passes through the communication position C and the magnetic processing position D. The communication operation is performed at the communication position C (step ST14). In the communication operation, the communication result storage unit 37 stores a communication result whether communication is successful in the storage unit 21 and holds the result therein (step ST15). The magnetic processing operation is performed at the magnetic processing position D (step ST16). In the magnetic processing operation, the determination storage unit 33 stores a determination result whether the card 100 has the magnetic stripe 101 in the storage unit 21 and holds the result therein (step ST17). The card 100 is then conveyed in the second direction G2 (step ST18) and ejected from the card insertion slot 4 (step ST19).

When the card 100 is ejected from the card insertion slot 4, the card reader 1 returns the shutter 11 to the closed position. When the card 100 is ejected from the card insertion slot 4, the card reader 1 performs a determination operation of determining whether the magnetic sensor 6 for detecting a magnetic stripe operates normally and whether the metal sensor 8 for detecting an IC chip operates normally (step ST20).

That is, when the card 100 is ejected from the card insertion slot 4, the card 100 passes through the IC chip detection position A of the metal sensor 8 for detecting an IC chip and the magnetic stripe detection position B of the magnetic sensor 6 for detecting a magnetic stripe. The magnetic stripe detection unit 31 thus detects the magnetic stripe 101 based on the signal from the magnetic sensor 6 for detecting a magnetic stripe. The IC chip detection unit 35 detects the IC chip 102 based on the signal from the metal sensor 8 for detecting an IC chip. The abnormality determination unit 45 performs a determination operation of determining whether the magnetic sensor 6 for detecting a magnetic stripe operates normally based on the determination result stored and held in the storage unit 21 and the detection result of the magnetic stripe 101 by the magnetic stripe detection unit 31. The abnormality determination unit 45 performs a determination operation of determining whether the metal sensor 8 for detecting an IC chip operates normally based on the communication result stored and held in the storage unit 21 and the detection result of the IC chip 102 by the IC chip detection unit 35.

As shown in FIG. 6, in the determination operation, when the magnetic stripe 101 is detected based on a signal from the magnetic head 7 in the magnetic processing operation but is not detected based on a signal from the magnetic sensor 6 for detecting a magnetic stripe (Yes at step ST21 and No at step ST22), it is determined that an abnormality occurs in the magnetic sensor 6 for detecting a magnetic stripe (step ST23). That is, when the magnetic stripe detection unit 31 does not detect the magnetic stripe 101 in a state where the determination result that the card 100 has the magnetic stripe 101 is stored in the storage unit 21, the detection result of the magnetic stripe 101 based on the signal from the magnetic head 7 is different from the detection result of the magnetic stripe 101 based on the signal from the magnetic sensor 6 for detecting a magnetic stripe. The abnormality determination unit 45 thus determines that an abnormality occurs in the magnetic sensor 6 for detecting a magnetic stripe. When it is determined that an abnormality occurs in the magnetic sensor 6 for detecting a magnetic stripe, the card reader 1 notifies the upper-level device 25 of the abnormality (step ST24).

On the other hand, when the magnetic stripe 101 is detected based on the signal from the magnetic head 7 in the magnetic processing operation and then detected based on the signal from the magnetic sensor 6 for detecting a magnetic stripe (Yes at step ST21 and Yes at step ST22), the card reader 1 determines that the magnetic sensor 6 for detecting a magnetic stripe is normal (step ST25). That is, when the magnetic stripe detection unit 31 detects the magnetic stripe 101 in a state where the determination result that the card 100 has the magnetic stripe 101 is stored in the storage unit 21, the detection result of the magnetic stripe 101 based on the signal from the magnetic head 7 matches the detection result of the magnetic stripe 101 based on the signal from the magnetic sensor 6 for detecting a magnetic stripe. The abnormality determination unit 45 thus determines that the magnetic sensor 6 for detecting a magnetic stripe is normal.

Additionally, in the determination operation, when the magnetic stripe 101 is not detected based on the signal from the magnetic head 7 in the magnetic processing operation but is detected based on the signal from the magnetic sensor 6 for detecting a magnetic stripe (No at step ST21 and Yes at step ST26), the card reader 1 determines that an abnormality occurs in the magnetic sensor 6 for detecting a magnetic stripe (step ST27). That is, when the magnetic stripe detection unit 31 detects the magnetic stripe 101 in a state where the determination result that the card 100 does not have the magnetic stripe 101 is stored in the storage unit 21, the detection result of the magnetic stripe 101 based on the signal from the magnetic head 7 is different from the detection result of the magnetic stripe 101 based on the signal from the magnetic sensor 6 for detecting a magnetic stripe. The abnormality determination unit 45 thus determines that an abnormality occurs in the magnetic sensor 6 for detecting a magnetic stripe. When it is determined that an abnormality occurs in the magnetic sensor 6 for detecting a magnetic stripe, the card reader 1 notifies the upper-level device 25 of the abnormality (step ST28).

When the magnetic stripe 101 is not detected based on the signal from the magnetic head 7 in the magnetic processing operation and then the magnetic stripe 101 is not detected based on the signal from the magnetic sensor 6 for detecting a magnetic stripe (No at step ST21 and No at step ST26), the card reader 1 informs the upper-level device 25 that the position of the card 100 is not correct (step ST29). That is, when the magnetic stripe detection unit 31 does not detect the magnetic stripe 101 in a state where the determination result that the card 100 does not have the magnetic stripe 101 is stored in the storage unit 21, the informing unit 47 informs the upper-level device 25 that the position of the card 100 is not correct.

As shown in FIG. 7, in the determination operation, when the IC contact block 9 communicates successfully with the IC chip 102 in the communication operation but the IC chip 102 is not detected based on a signal from the metal sensor 8 for detecting an IC chip (Yes at step ST31 and No at step ST32), the card reader 1 determines that an abnormality occurs in the metal sensor 8 for detecting an IC chip (step ST33). That is, when the IC chip detection unit 35 does not detect the IC chip 102 in a state where the communication result that communication is successful is stored in the storage unit 21, the IC chip detection unit 35 cannot detect the IC chip 102 though the IC chip 102 is confirmed by the successful communication. The abnormality determination unit 45 thus determines that an abnormality occurs in the metal sensor 8 for detecting an IC chip. When it is determined that an abnormality occurs in the metal sensor 8 for detecting an IC chip, the card reader 1 notifies the upper-level device 25 of the abnormality (step ST34).

On the other hand, in the determination operation, when the IC contact block 9 communicates successfully with the IC chip 102 in the communication operation and then the IC chip 102 is detected based on the signal from the metal sensor 8 for detecting an IC chip (Yes at step ST31 and Yes at step ST32), the card reader 1 determines that the metal sensor 8 for detecting an IC chip is normal (step ST35). That is, when the IC chip detection unit 35 detects the IC chip 102 in a state where the communication result that communication is successful is stored in the storage unit 21, the detection result of the IC chip 102 by the IC chip detection unit 35 is correct because the IC chip 102 is confirmed by the successful communication. The abnormality determination unit 45 thus determines that the metal sensor 8 for detecting an IC chip is normal.

In the determination operation, when communication between the IC contact block 9 and the IC chip 102 fails in the communication operation but the IC chip 102 is detected based on the signal from the metal sensor 8 for detecting an IC chip (No at step ST31 and Yes at step ST36), the card reader 1 determines that an abnormality occurs in the metal sensor 8 for detecting an IC chip (step ST37). That is, when the IC chip detection unit 35 detects the IC chip 102 in a state where the communication result that communication fails is stored in the storage unit 21, the IC chip detection unit 35 detects the IC chip 102 though it is confirmed by the failed communication that the card 100 does not have the IC chip 102. The abnormality determination unit 45 thus determines that an abnormality occurs in the metal sensor 8 for detecting an IC chip. When it is determined that an abnormality occurs in the metal sensor 8 for detecting an IC chip, the card reader 1 notifies the upper-level device 25 of the abnormality (step ST38).

When communication fails in the communication operation and then the IC chip 102 is not detected based on the signal from the metal sensor 8 for detecting an IC chip (No at step ST31 and No at step ST36), the card reader 1 informs the upper-level device 25 that the position of the card 100 is not correct (step ST39). That is, when the IC chip detection unit 35 does not detect the IC chip 102 in a state where the determination result that communication fails is stored in the storage unit 21, the informing unit 47 informs the upper-level device that the position of the card 100 is not correct.

When the abnormality determination unit 45 determines that the magnetic sensor 6 for detecting a magnetic stripe and the metal sensor 8 for detecting an IC chip are normal, the operation of the card reader 1 returns to the normal operation shown in FIG. 4. That is, in the card reader 1, when insertion of the card 100 into the card insertion slot 4 is detected by the card detector 5, the magnetic stripe 101 is detected based on a signal from the magnetic sensor 6 for detecting a magnetic stripe, and the IC chip 102 (the contact terminals 102a) is detected based on the signal from the metal sensor 8 for detecting an IC chip, the conveyance mechanism 15 is driven and the shutter 11 is moved from the closed position to the open position. The card 100 is thus conveyed in the first direction G1 and passes through the communication position C and the magnetic processing position D. The communication operation is performed at the communication position C and the magnetic processing operation is performed at the magnetic processing position D. The card 100 is then conveyed in the second direction G2 to be ejected from the card insertion slot 4.

### (Operations and Effects)

According to the present embodiment, it is possible to determine whether a defect is present in the magnetic sensor 6 for detecting a magnetic stripe that detects the magnetic stripe 101 on the card 100. Further, according to the present embodiment, it is possible to determine whether a defect is present in the metal sensor 8 for detecting an IC chip that detects the IC chip 102 on the card 100. When a defect is present in the magnetic sensor 6 for detecting a magnetic stripe or in the metal sensor 8 for detecting an IC chip, the upper-level device 25 can detect the defect.

In addition, according to the present embodiment, it is possible to detect an abnormality in the magnetic sensor 6 for detecting a magnetic stripe and an abnormality in the metal sensor 8 for detecting an IC chip during the magnetic processing operation and the communication operation in the card reader 1.

The card reader 1 may process the card 100 that includes only the magnetic stripe 101. In this case, the metal sensor 8 for detecting an IC chip and the IC contact block 9 may be removed from the card reader 1. The IC chip detection unit 35 and the IC contact block control unit 36 may also be removed from the control unit 20 and the operation of detecting an abnormality in the metal sensor 8 for detecting an IC chip may be omitted.

Alternatively, the card reader 1 may process the card 100 that includes only the IC chip 102. In this case, the magnetic sensor 6 for detecting a magnetic stripe and the magnetic head 7 may be removed from the card reader 1. The magnetic stripe detection unit 31 and the magnetic head control unit 32 may also be removed from the control unit 20 and the operation of detecting an abnormality in the magnetic sensor 6 for detecting a magnetic stripe may be omitted.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A control method of a card reader, the card reader comprising a magnetic sensor for detecting a magnetic stripe that detects a magnetic stripe on a card inserted into a card insertion slot, a magnetic head that performs a magnetic processing operation that is at least one of reading magnetic information from the magnetic stripe and writing magnetic information in the magnetic stripe, a card conveying passage that extends from the card insertion slot through a detection position of the magnetic sensor and a magnetic processing position of the magnetic head in this order, and a conveyance mechanism that conveys the card in a first direction from the card insertion slot toward the magnetic processing position and in a second direction opposite to the first direction along the card conveying passage, when the magnetic stripe is detected based on a signal from the magnetic sensor, the card is conveyed in the first direction by the conveyance mechanism to be subjected to the magnetic processing operation while passing through the magnetic processing position, and the card is then conveyed in the second direction to be ejected from the card insertion slot, the method comprising:
at a predetermined timing set in advance, regardless of whether the magnetic stripe is detected, conveying the card inserted into the card insertion slot in the first direction to be subjected to the magnetic processing operation while passing through the magnetic processing position and then conveying the card in the second direction to be ejected from the card insertion slot, and
when the magnetic stripe is detected based on a signal from the magnetic head in the magnetic processing operation but is not detected based on a signal from the magnetic sensor, determining that an abnormality occurs in the magnetic sensor.

2. The control method of a card reader according to claim 1, further comprising when the magnetic stripe is not detected based on a signal from the magnetic head in the magnetic processing operation but is detected based on a signal from the magnetic sensor, determining that an abnormality occurs in the magnetic sensor.

3. The control method of a card reader according to claim 1, further comprising when the magnetic stripe is not detected based on a signal from the magnetic head in the magnetic processing operation and then is not detected based on a signal from the magnetic sensor, determining that a position of the card is not correct.

4. The control method of a card reader according to claim 1, further comprising when the magnetic stripe is detected based on a signal from the magnetic head in the magnetic processing operation and then is detected based on a signal from the magnetic sensor, determining that the magnetic sensor is normal.

5. The control method of a card reader according to claim 1, further comprising when it is determined that an abnormality occurs in the magnetic sensor, notifying the abnormality to a communicably connected external device.

6. The control method of a card reader according to claim 1, wherein
the card reader comprises a shutter that opens and closes the card conveying passage between the detection position and the magnetic processing position, the shutter is closed,
when the card is inserted into the card insertion slot at the predetermined timing, the shutter is opened, and the method further comprises
when it is determined that the magnetic sensor is normal and then the card is inserted into the card insertion slot, in a case where the magnetic stripe is detected based on a signal from the magnetic sensor, opening the shutter, and in a case where the magnetic stripe is not detected based on a signal from the magnetic sensor, keeping the shutter closed.

7. The control method of a card reader according to claim 1, wherein
the card reader comprises a metal sensor for detecting an IC chip that detects an IC chip on the card inserted into the card insertion slot and an IC contact block that performs a communication operation with the IC chip,
an IC chip detection position of the metal sensor for detecting an IC chip and a communication position of the IC contact block are set in this order on the card conveying passage from the card insertion slot toward a downstream side in a first direction,
at the predetermined timing, the card inserted into the card insertion slot is conveyed in the first direction to be subjected to the magnetic processing operation while passing through the magnetic processing position and to the communication operation at the communication position, and the card is then conveyed in the second direction to be ejected from the card insertion slot, and
when communication between the IC contact block and the IC chip is successful in the communication operation but the IC chip is not detected based on a signal from the metal sensor for detecting an IC chip, it is determined that an abnormality occurs in the metal sensor for detecting an IC chip.

8. The control method of a card reader according to claim 7, further comprising when communication between the IC contact block and the IC chip fails in the communication operation but the IC chip is detected based on a signal from the metal sensor for detecting an IC chip, determining that an abnormality occurs in the metal sensor for detecting an IC chip.

9. A control method of a card reader, the card reader comprising a metal sensor for detecting an IC chip that detects an IC chip on a card inserted into a card insertion slot, an IC contact block that performs a communication operation with the IC chip, a card conveying passage that extends from the card insertion slot through an IC chip detection position of the metal sensor for detecting an IC chip and a communication position of the IC contact block in this order, and a conveyance mechanism that conveys the card in a first direction from the card insertion slot toward the communication position and in a second direction opposite to the first direction along the card conveying passage, when the IC chip is detected based on a signal from the metal sensor for detecting an IC chip, the card is conveyed in the first direction by the conveyance mechanism to be subjected to the communication operation at the communication position, and the card is then conveyed in the second direction to be ejected from the card insertion slot, the method further comprising:
at a predetermined timing set in advance, regardless of whether the IC chip is detected, conveying the card inserted into the card insertion slot in the first direction to be subjected to the communication operation at the communication position and then conveying the card in the second direction to be ejected from the card insertion slot, and
when communication between the IC contact block and the IC chip is successful in the communication operation but the IC chip is not detected based on a signal from the metal sensor for detecting an IC chip, determining that an abnormality occurs in the magnetic sensor.

10. The control method of a card reader according to claim 9, further comprising when communication between the IC contact block and the IC chip fails in the communication operation but the IC chip is detected based on a signal from the metal sensor for detecting an IC chip, determining that an abnormality occurs in the metal sensor for detecting an IC chip.

11. A card reader comprising for use with a card having a magnetic stripe, the card reader comprising:
a card detector structured to detect insertion of the card into a card insertion slot;
a magnetic sensor structured to detect a magnetic stripe that detects on the card inserted into the card insertion slot;
a magnetic head structured to perform a magnetic processing operation that is at least one of reading magnetic information from the magnetic stripe and writing magnetic information in the magnetic stripe;
a card conveying passage that extends from the card insertion slot through a magnetic stripe detection position of the magnetic sensor a magnetic processing position of the magnetic head in this order;
a conveyance mechanism structured to convey the card in a first direction from the card insertion slot toward the magnetic processing position and in a second direction opposite to the first direction along the card conveying passage;
a storage unit;
a magnetic stripe detection unit structured to detect whether the card has the magnetic stripe based on a signal from the magnetic sensor;
a first conveyance control unit structured such that, when insertion of the card into the card insertion slot is detected and the magnetic stripe detection unit detects the magnetic stripe, the conveyance mechanism is driven to convey the card in the first direction to cause the card to pass through the magnetic processing position and then convey the card in the second direction to eject the card from the card insertion slot;
a second conveyance control unit structured such that, when insertion of the card into the card insertion slot is detected at a predetermined timing set in advance, the conveyance mechanism is driven, regardless of whether the magnetic stripe detection unit detects the magnetic stripe, to convey the card in the first direction to cause the card to pass through the magnetic processing position and then convey the card in the second direction to eject the card from the card insertion slot;
a magnetic head control unit structured to drive the magnetic head to perform the magnetic processing operation on the card passing through the magnetic processing position;
a determination storage unit structured to determine whether the card has the magnetic stripe based on a signal from the magnetic head in the magnetic processing operation, and store and hold a determination result in the storage unit; and
an abnormality determination unit structured to determine that an abnormality occurs in the magnetic sensor when the magnetic stripe detection unit does not detect the magnetic stripe in a state where the determination result that the card has the magnetic stripe is stored in the storage unit.

12. The card reader according to claim 11, wherein the abnormality determination unit is structured to determine that an abnormality occurs in the magnetic sensor when the magnetic stripe detection unit detects the magnetic stripe in a state where the determination result that the card does not have the magnetic stripe is stored in the storage unit.

13. The card reader according to claim 11, further comprising an informing unit structured to determine an upper-level device that a position of the card is not correct when the magnetic stripe detection unit does not detect the magnetic stripe in a state where the determination result that the card does not have the magnetic stripe is stored in the storage unit.

14. The card reader according to claim 11, wherein the abnormality determination unit is structured to determine that the magnetic sensor is normal when the magnetic stripe detection unit detects the magnetic stripe in a state where the determination result that the card has the magnetic stripe is stored in the storage unit.

15. The card reader according to claim 11, further comprising a notification unit structured to, when the abnormality determination unit determines that an abnormality occurs in the magnetic sensor, notify a communicably connected external device of the abnormality.

16. The card reader according to claim 11 further comprising:
a shutter that opens and closes the card conveying passage between the magnetic stripe detection position and the magnetic processing position;
a shutter movement mechanism structured to move the shutter between a closed position where the card conveying passage is closed and an open position where the card conveying passage is opened; and
a shutter control unit structured to drive the shutter movement mechanism to move the shutter at the closed position to the open position when insertion of the card into the card insertion slot is detected at the predetermined timing, wherein
when it is determined that the magnetic sensor is normal and then insertion of the card into the card insertion slot is detected, if the magnetic stripe is detected based on a signal from the magnetic sensor, the shutter control unit drives the shutter movement mechanism to move the shutter at the closed position to the open position, and if the magnetic stripe is not detected based on a signal from the magnetic sensor, the shutter control unit keeps the shutter at the closed position.

17. The card reader according to claim 11, further comprising:
a metal sensor structured to detect an IC chip that detects an IC chip on the card inserted into the card insertion slot;
an IC contact block structured to perform a communication operation with the IC chip;
an IC chip detection unit structured to detect the IC chip based on a signal from the metal sensor for detecting an IC chip;
an IC contact block control unit structured to drive the IC contact block to perform a communication operation with the IC chip and obtains a communication result whether communication is successful; and
a communication result storage unit structured to store a communication result whether communication between the IC chip and the IC contact block is successful in the storage unit, wherein
the card conveying passage extends from the card insertion slot toward a downstream side in a first direction through an IC chip detection position of the metal sensor for detecting an IC chip and a communication position of the IC contact block,
when the IC chip detection unit detects the IC chip, the first conveyance control unit drives the conveyance mechanism and conveys the card in the first direction to cause the card to pass through the IC chip detection position and the communication position and then conveys the card in the second direction to eject the card from the card insertion slot;
the second conveyance control unit is structured to drive the conveyance mechanism regardless whether the IC chip detection unit detects the IC chip to convey the card in the first direction to cause the card to pass through the IC chip detection position and the communication position and then conveys the card in a second direction to eject the card from the card insertion slot, and wherein
the abnormality determination unit is structured to determine that an abnormality occurs in the metal sensor for detecting an IC chip when the IC chip detection unit does not detect the IC chip in a state where the communication result that communication is successful is stored in the storage unit.

18. The card reader according to claim 17, wherein the abnormality determination unit is structured to determine that an abnormality occurs in the metal sensor for detecting an IC chip when the IC chip detection unit detects the IC chip in a state where the communication result that communication fails is stored in the storage unit.

19. A card reader comprising for use with a card comprising an IC chip, the card reader comprising:
a card detector structured to detect insertion of a card into a card insertion slot;
a metal sensor structured to detect an IC chip on the card inserted into the card insertion slot;
an IC contact block structured to perform a communication operation with the IC chip;
a card conveying passage that extends from the card insertion slot through an IC chip detection position of the metal sensor for detecting an IC chip and a communication position of the IC contact block in this order;
a conveyance mechanism structured to convey the card in a first direction from the card insertion slot toward the communication position and in a second direction opposite to the first direction along the card conveying passage;
a storage unit;
an IC chip detection unit structured to detect the IC chip based on a signal from the metal sensor for detecting an IC chip;
a first conveyance control unit structured to, when insertion of the card into the card insertion slot is detected and the IC chip detection unit detects the IC chip, drive the conveyance mechanism to convey the card in the first direction to cause the card to pass through the communication position and then convey the card in the second direction to eject the card from the card insertion slot;
a second conveyance control unit structured to, when insertion of the card into the card insertion slot is detected at a predetermined timing set in advance, drive the conveyance mechanism regardless of whether the IC chip detection unit detects the IC chip to convey the card in the first direction to cause the card to pass through the communication position and then convey the card in the second direction to eject the card from the card insertion slot;
an IC contact block control unit structured to drive the IC contact block to perform the communication operation with the IC chip and obtains a communication result whether communication is successful;
a communication result storage unit structured to store and hold a communication result whether communication is successful in the storage unit; and
an abnormality determination unit structured to determine that an abnormality occurs in the metal sensor for detecting an IC chip when the IC chip detection unit does not detect the IC chip in a state where the communication result that the communication is successful is stored in the storage unit.

20. The card reader according to claim 19, wherein the abnormality determination unit is structured to determine that an abnormality occurs in the metal sensor for detecting an IC chip when the IC chip detection unit detects the IC chip in a state where the communication result that the communication fails is stored in the storage unit.
